(19) United States
(12) Patent Application Publication
(10) Pub. No.: US 2004/0062964 A1
(43) Pub. Date: Apr. 1, 2004

(54) Direct methanol fuel cell system

(75) Inventors: Kei Matsuoka, Kawasaki-shi (JP); Yuusuke Sato, Tokyo (JP); Koichiro Kawano, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/668,965

(22) Filed: Sep. 24, 2003

(30) Foreign Application Priority Data
Sep. 30, 2002 (JP) 2002-287943

(51) Int. Cl. H01M 8/04

(52) U.S. Cl. 429/26; 429/34

(57) ABSTRACT

A fuel cell system having one or more anodes, one or more cathodes and electrolytes put therebetween is provided with a fuel supply unit, an air supply unit and a heat exchanger. The fuel supply unit supplies fuel to the anodes. The air supply unit supplies air to the cathodes. The heat exchanger is provided with a drain connected to the fuel supply unit and exchanges heat between the air supplied to the cathodes and exhaust gas exhausted from the anode so as to condense water from the exhaust gas and discharge the water to the drain.

### CROSS-REFERENCE TO RELATED APPLICATIONS

This application is based upon and claims the benefit of priority from the prior Japanese Patent Application No. 2002-287943 (filed Sep. 30, 2002); the entire contents of which are incorporated herein by reference.

### BACKGROUND OF THE INVENTION

1. Field of the Invention

The present invention relates to a direct fuel cell system to which an organic compound such as methanol is directly supplied as a fuel so that the fuel cell system is compactly constituted and, more particularly, to a direct fuel cell system in which water generated therein is properly processed so that the fuel cell system is compactly constituted and provides an easy operability.

2. Description of the Related Art

Application of a fuel cell to a battery for a mobile device is diligently considered. The fuel cell has an advantage that the fuel cell can be repeatedly utilized by recharging a fuel thereto, however, has a problem that the fuel cell is difficult to be compact because it needs additional equipment of a fuel tank and a reformer to extract hydrogen from the fuel.

Related arts are disclosed in Japanese Patent Application Laid-open No. H2-44653, No. H2-86070, No. H4-115468 and No. 2002-110199.

A direct fuel cell is a modification of the fuel cell wherein fuel is directly supplied to the fuel cell without reforming so as to generate electric power. The direct fuel cell need not be provided with a reformer for reforming the fuel thereby it is advantageous for downsizing thereof. A direct methanol fuel cell (DMFC) is proposed as the direct fuel cell.

The direct methanol fuel cell is composed of an anode, a cathode and a solid electrolyte film sandwiched therebetween, similar to a usual fuel cell. The solid electrolyte film is necessary to be humidified. To supply water to the solid electrolyte, methanol aqueous solution diluted by water in an adequate concentration is employed as the fuel.

### SUMMARY OF THE INVENTION

In a case where the methanol aqueous solution is employed as the fuel as described above, energy concentration per volume of the fuel tank is suppressed in an extent of dilution by the water. To get larger battery capacity, a larger fuel tank must be applied. This is a problem required to be improved in a case of electronic devices which should be made compact, such as a mobile device. The present invention is intended for overcoming the problem.

In the course of the inventors' research, it is discovered that exhaust gas exhausted from the cathode of DMFC includes a large amount of water caused by battery reaction and the water can be utilized to overcome the problem. The present invention is achieved on the basis of the discovery and devising a constitution of an exhaust gas system of DMFC so as to effectively control and utilize the water contained in the exhaust gas.

According to a first aspect of the present invention, a fuel cell system is provided with a fuel cell having one or more anodes, one or more cathodes and electrolytes respectively put therebetween, a fuel supply unit supplying fuel to the anodes, an air supply unit supplying air to the cathodes and a heat exchanger having a drain connected to the fuel supply unit. The heat exchanger exchanges heat between the air supplied to the cathodes and exhaust gas exhausted from the anodes so as to condense water from the exhaust gas and discharge the water to the drain.

Because the condensed water is re-circulated to the fuel supply unit and utilized, the fuel need not be diluted by water in advance and concentrated fuel such as concentrated methanol can be employed. Therefore the fuel cell system can have a large battery capacity even if the fuel cell system is compactly constituted.

According to a second aspect of the present invention, a fuel cell system is provided with a fuel cell having one or more anodes, one or more cathodes and electrolytes respectively put therebetween, a fuel supply unit supplying fuel to the anodes, an air supply unit supplying air to the cathodes and a heat exchanger having a drain connected to the fuel supply unit. The heat exchanger exchanges heat between the fuel supplied to the anode and exhaust gas exhausted from the anodes so as to condense water from the exhaust gas and discharge the water to the drain.

Because the condensed water is re-circulated to the fuel supply unit and utilized, the fuel need not be diluted by water in advance and concentrated fuel such as concentrated methanol can be employed. Therefore the fuel cell system can have a large battery capacity even if the fuel cell system is compactly constituted.

According to a third aspect of the present invention, a fuel cell system is provided with a fuel cell having one or more anodes, one or more cathodes and electrolytes respectively put therebetween, a fuel supply unit supplying fuel to the anodes and an air supply unit supplying air to the cathodes. The air supply unit is configured to retrieve a portion of exhaust gas exhausted from the cathodes and admix the portion with the air.

The water contained in the retrieved exhausted gas is conducted to the cathodes. This retrieval reduces the loss of the water in the exhausted gas which is failed to be condensed and is emitted outside, because the emitted gas flow rate after the retrieval is smaller than the conventional non-retrieval system.

According to a fourth aspect of the present invention, a fuel cell system is provided with a fuel cell having one or more anodes, one or more cathodes and electrolytes respectively put therebetween, a fuel supply unit supplying fuel to the anodes, an air supply unit supplying air to the cathodes, a heat exchanger having a drain connected to the fuel supply unit and an outside air introduction unit. The outside air introduction unit introduces outside air and admix the outside air with the exhaust gas from the cathodes immediately prior to exhaustion of the exhaust gas to an outside.

Because the exhaust gas is mixed with the outside air to be diluted, it is prevented that a portion of water contained in the exhaust gas, which is not retrieved, is condensed so as to form dew on a chassis. Therefore malfunction of the device can be prevented.

### BRIEF DESCRIPTION OF THE DRAWINGS

FIG. 1 is a schematic drawing of a direct fuel cell system according to a first embodiment of the present invention;

FIG. 2 is a schematic drawing of a direct fuel cell system according to a second embodiment of the present invention;

FIG. 3 is a schematic drawing of a direct fuel cell system according to a third embodiment of the present invention;

FIG. 4 is a schematic drawing of a direct fuel cell system according to a fourth embodiment of the present invention;

FIG. 5A is a schematic drawing of a first modification of the direct fuel cell system;

FIG. 5B is a schematic drawing of a second modification of the direct fuel cell system;

FIG. 6 is a schematic drawing of a direct fuel cell system according to a fifth embodiment of the present invention;

FIG. 7 is a schematic drawing of a direct fuel cell system according to a sixth embodiment of the present invention; and

FIG. 8 is a schematic drawing of a direct fuel cell system according to a seventh embodiment of the present invention.

### DETAILED DESCRIPTION OF THE INVENTION

Embodiments will be described hereinafter. In these descriptions, methanol is exemplified as a fuel, however, any appropriate liquid organic compounds having water solubility can be applied, for example, ethanol, dimethyl ether and formic acid.

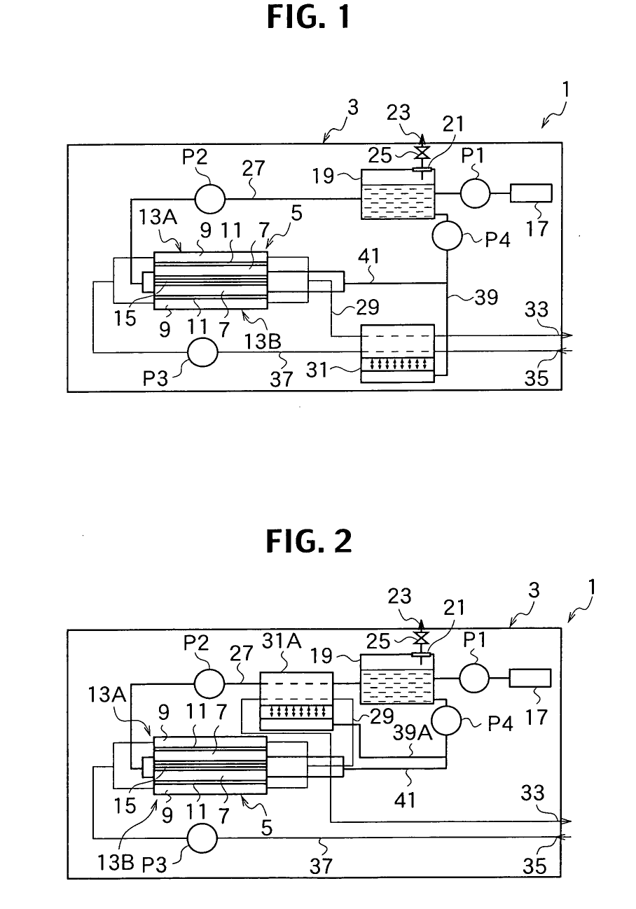

A first embodiment of the present invention will be described hereinafter with reference to FIG. 1.

A fuel battery 1 is provided with a chassis 3 for housing constituent elements thereof. A fuel cell 5 housed in the chassis 3 is provided with unit cells 13A and 13B and a heater 15 put therebetween. Each of the unit cells 13A, 13B is provided with an anode 7, which is provided with a catalysis for oxidation of methanol so as to extract electrons by oxidation reaction, a cathode 9, which is provided with a catalysis for reduction of oxygen so as to receive the electrons by reduction reaction, and an electrolyte film 11 put therebetween. In the description of the first embodiment, a case in which the fuel battery includes two unit cells is exemplified, however, one unit cell or three or more unit cells can be applied to the fuel battery.

The chassis 3 further houses fuel supply means for supplying methanol as fuel to the anodes 7. The fuel supply means is provided with a tank 17 for pooling the methanol, a pump P1 for delivery of the methanol and a mixing buffer tank 19.

The mixing buffer tank 19 is provided for mixing exhaust gas and recovered water, to be described later, and is provided with a gas-liquid separation membrane 21, a valve 25 and an exhaust vent 23 which communicates with an outside. The mixing buffer tank 19 further communicates with the anodes 7 via a fuel supply path 27 and a pump P2 so as to supply the methanol mixed with the water to the anodes 7.

For supplying air to the cathodes 9, the chassis 3 is provided with an intake vent 35 opened on an outside thereof. The intake vent 35 communicates with an air supply path 37 via a heat exchanger 31. A pump P3 is connected onto the air supply path 37 so as to supply the air to the cathodes 9. The cathodes 9 are connected to the heat exchanger 31 via an exhaust path 29 and are further connected to an exhaust vent 33 communicating with the outside of the chassis 3. Thereby exhaust gas exhausted from the cathodes 9 is discharged to the outside. By means of the heat exchanger 31, the exhaust gas exchanges heat with the air.

The heat exchanger 31 houses a drainer for retrieving condensed water, which is connected to a drain 39. The drain 39 is further connected to the mixing buffer tank 19 via a pump P4. An exhaust path 41 which is connected to an exhaust port of the anodes 7 is connected to the drain 39.

The methanol pooled in the tank 17 is delivered by the pump P2 and supplied to the respective anodes 7 of the fuel cells 5. Simultaneously, the air is delivered by the pump P3 and supplied to the respective cathodes 9. Thereby electric power is generated by the fuel cell 5. Accompanied with the power generation, water is generated at the respective cathodes 9.

The water involved in the exhaust gas containing unreacted oxygen is transported to the heat exchanger 31 via the exhaust path 29. The air which has a lower temperature is conducted from the outside to the heat exchanger 31 so as to be exchange heat with the exhaust gas, thereby the water is condensed and retrieved. The exhaust gas from which the water is retrieved so as to be cooled is discharged out of the exhaust vent 33 to the outside.

The water condensed at the heat exchanger 31 is mixed with exhaust gas exhausted from the anodes 7 and is delivered to the mixing buffer tank 19 via the drain 39 by the pump P4. The water in a liquid phase is separated from the mixed exhaust gas by the gas-liquid separation membrane 21 of the mixing buffer tank 19. The water is mixed to the methanol and unnecessary gas such as carbon dioxide contained in the exhaust gas is discharged out of the exhaust vent 23 to the outside.

The water mixed with the methanol is supplied to the anodes 7 so as to humidify the electrolyte films 11. It is not necessary to admix water for humidifying the electrolyte films 11 with the methanol in advance. Therefore the methanol to be pooled in the tank 17 can be concentrated methanol. More specifically, energy density per volume of the tank 17 can be made high so that a capacity of the fuel battery 1 can be made large even in the tank 17 is compact.

Because the air having a lower temperature is utilized to condense the water by means of the heat exchanger 31, another cooling means such as a fan can be omitted. The fuel battery 1 can be further made compact. Additionally, the temperature of the air gets higher by the heat exchange so that the reaction at the fuel cells 5 gets higher efficiency.

Furthermore, because the exhaust gas exhausted from the anodes 7 is retrieved, unreacted methanol can be recycled. This causes higher fuel efficiency.

A second embodiment of the present invention will be described hereinafter with reference to FIG. 2. In the second embodiment, the same elements as the above first embodiment are referenced with the same numerals and the detailed descriptions are omitted. Mainly differences are described below.

The heat exchanger 31 of the first embodiment is connected to the air supply path 37, however, according to the second embodiment, a heat exchanger 31A is connected to the fuel supply path 27. The exhaust gas exhausted from the cathodes 9 exchanges heat with the methanol so as to condense the water contained therein.

The condensed water is, similar to the first embodiment, delivered to the mixing buffer tank 19 and utilized to humidify the electrolyte films 11. Therefore the same effect is obtained as the first embodiment.

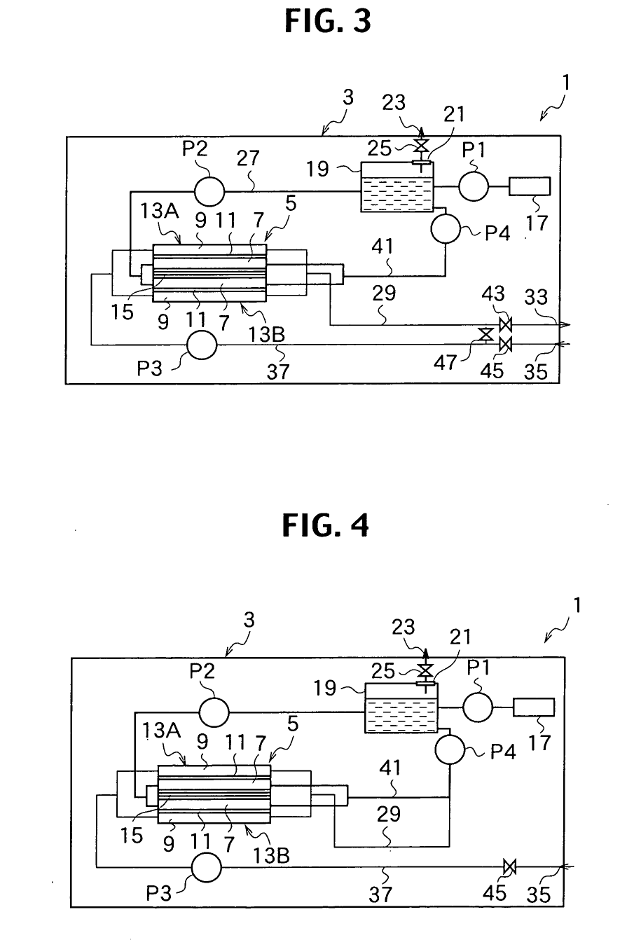

A third embodiment of the present invention will be described hereinafter with reference to FIG. 3. In the third embodiment, the same elements as the above first and second embodiments are referenced with the same numerals and the detailed descriptions are omitted. Mainly differences are described below.

According to the third embodiment, the fuel battery 1 is not provided with a heat exchanger. The intake vent 35 is connected to the air supply path 37 via a valve 45 and the air supply path 37 is branched before the pump P3 to be connected to the exhaust path 29 via a valve 47. The exhaust path 29 is connected to the exhaust vent 33 via a valve 43. The exhaust path 41 is, without communicating with the exhaust path 29, connected to the mixing buffer tank 19 via the pump P4. Valve travel of the respective valves 43, 45 and 47 can be individually controlled.

According to the third embodiment, the valve travel of the respective valves 43, 45 and 47 is appropriately controlled so that the exhaust gas exhausted from the cathodes 9 can be partly conducted to the air supply path 37. The water is circulated to the cathodes 9 so as to humidify the electrolyte films 11 without condensation of the water. The water can be quickly utilized to humidify the electrolyte films 11 because the water does not go through a condensation phase.

A fourth embodiment of the present invention will be described hereinafter with reference to FIG. 4. In the fourth embodiment, the same elements as the above first to third embodiments are referenced with the same numerals and the detailed descriptions are omitted. Mainly differences are described below.

According to the fourth embodiment, the exhaust vent 33 is omitted. The exhaust path 29 is merged to the exhaust path 41 and further connected to the mixing buffer tank 19 via the pump P4. More specifically, all the exhaust gas exhausted from the cathodes 9 is conducted to the mixing buffer tank 19.

The water contained in the exhaust gas is absorbed into the methanol when passing through the mixing buffer tank 19 so as to be utilized to humidify the electrolyte films 11. The electrolyte films 11 are effectively humidified by means of the simple constitution in this way.

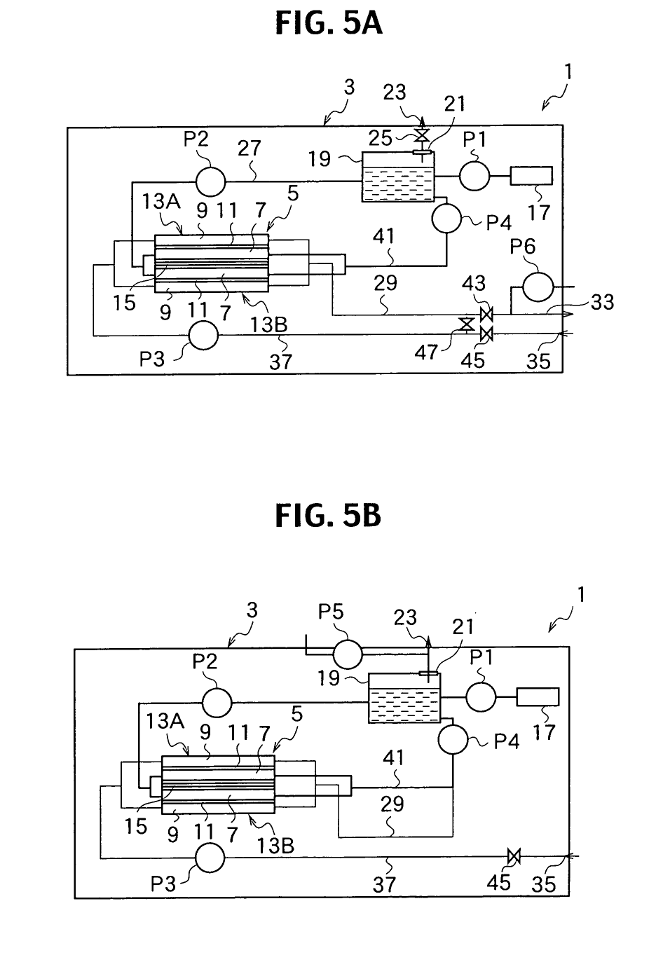

Modifications of the aforementioned embodiments will be described hereinafter with reference to FIGS. 5A and 5B.

According to a first modification shown in FIG. 5A, a pump P6 is provided for introduction of outside air to the exhaust gas exhausted from the anodes 7 and is connected to a slightly upstream of the exhaust vent 33. According to a second modification shown in FIG. 5B, a pump P5 is provided for introduction of outside air to the exhaust gas exhausted from the cathodes 9 and is connected to a slightly upstream of the exhaust vent 23.

The exhaust gas just after passing through the gas-liquid separation membrane 21 or the valve 43 contains water vapor having nearly saturated vapor pressure. In a case where the exhaust gas reaches the exhaust vent 33 or 23, the exhaust gas is rapidly cooled and tends to form dew which might adversely affects the other devices. According to the modifications, the exhaust gas is diluted with the outside air conducted by the pump P6 or P5 before reaching the exhaust vent 33 or 23, thereby the dew forming is prevented.

The above modifications, in which the pump P5 or P6 for introduction of the outside air is added to the fuel battery of the third or fourth embodiment, has been mentioned. Similar modifications of the first and second embodiment can be possible and are expected to have the same effect. Addition of both the pump P6 and P5 can be further possible.

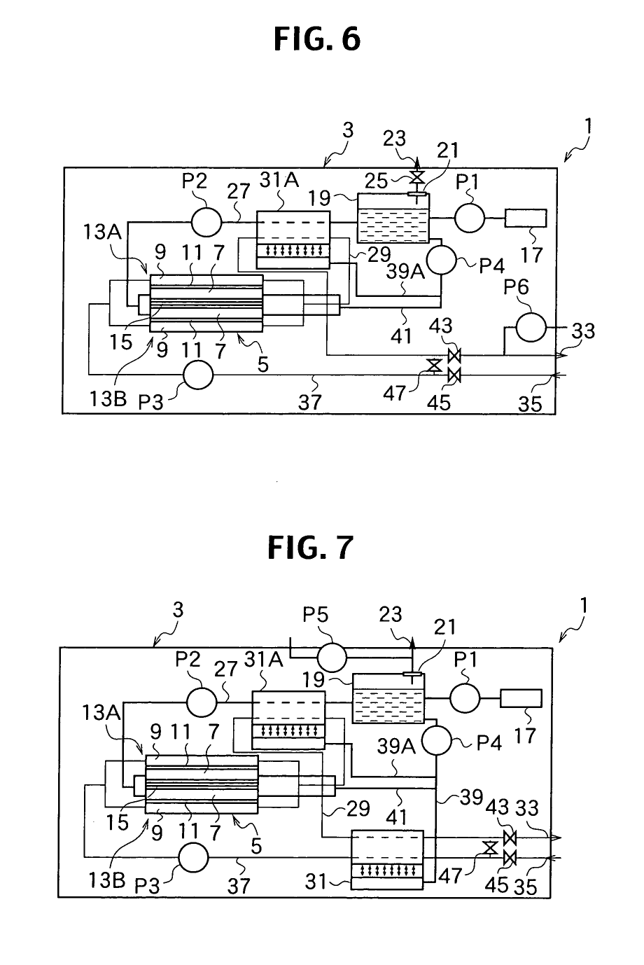

A fifth embodiment of the present invention will be described hereinafter with reference to FIG. 6. In the fifth embodiment, the same elements as the above first to fourth embodiments are referenced with the same numerals and the detailed descriptions are omitted. Mainly differences are described below.

A fuel battery 1 of the present embodiment has a constitution into which the second embodiment is combined with the third embodiment and is further provided with the pump P6 described in the above first modification. More specifically, the exhaust gas exhausted from the cathodes 9 is conducted to the heat exchanger 31A connected to the fuel supply path 27. The exhaust gas exchanges heat with the methanol so that the water is condensed. The condensed water is delivered to the mixing buffer tank 19 via the drain 39A and is utilized for humidifying the electrolyte films 11. The exhaust gas in part is further conducted to the air supply path 37 via the valve 47 so that the water contained therein is recycled. By means of the pump P6 to dilute the exhaust gas with the outside air, the dew forming is prevented.

A sixth embodiment of the present invention will be described hereinafter with reference to FIG. 7. In the sixth embodiment, the same elements as the above first to fifth embodiments are referenced with the same numerals and the detailed descriptions are omitted. Mainly differences are described below.

According to the present embodiment, the exhaust path 29 is conducted to the heat exchanger 31A and further conducted to the heat exchanger 31. At a downstream thereof, the exhaust path 29 is branched and connected to the air supply path 37 via the valve 47. At a further downstream thereof, the exhaust path 29 is connected to the exhaust vent 33 via the valve 43.

The heat exchanger 31A is connected to the drain 39A and the heat exchanger 31 is connected to the drain 39. The drain 39a and the drain 39 are further connected to the exhaust path 41 and sequentially connected to the mixing buffer tank 19 via the pump P4. The gas-liquid separation membrane 21 directly communicates with the outside without the valve 25, however, the pump P5 to introduce the outside air is connected to a halfway thereof.

The present embodiment is relevant to an embodiment into which the first to fourth embodiments are appropriately combined and has the same effect.

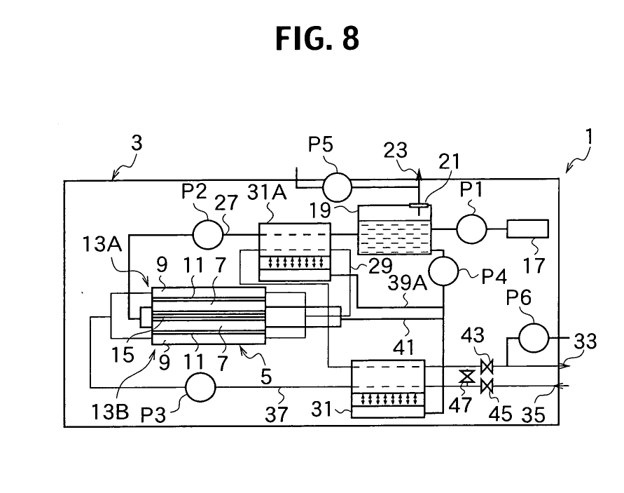

A seventh embodiment of the present invention will be described with reference to FIG. 8. The fuel battery 1 of the present embodiment has a constitution into which the constitutions of the first to fourth are combined and is further provided with the pump P5 and P6. The present embodiment has the same effect as the above embodiments and further prevents the dew forming by means of the pump P5 and P6.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A fuel cell system comprising a fuel cell having one or more anodes, one or more cathodes and electrolytes respectively put therebetween, comprising:
a fuel supply unit supplying fuel to the anodes;
an air supply unit supplying air to the cathodes; and
a heat exchanger having a drain connected to the fuel supply unit, the heat exchanger exchanging heat between the air supplied to the cathode and exhaust gas exhausted from the anode so as to condense water from the exhaust gas and discharge the water to the drain.

2. A fuel cell system comprising a fuel cell having one or more anodes, one or more cathodes and electrolytes respectively put therebetween, comprising:
a fuel supply unit supplying fuel to the anodes;
an air supply unit supplying air to the cathodes; and
a heat exchanger having a drain connected to the fuel supply unit, the heat exchanger exchanging heat between the fuel supplied to the anodes and exhaust gas exhausted from the anodes so as to condense water from the exhaust gas and discharge the water to the drain.

3. A fuel cell system comprising a fuel cell having one or more anodes, one or more cathodes and electrolytes respectively put therebetween, comprising:
a fuel supply unit supplying fuel to the anodes; and
an air supply unit supplying air to the cathodes wherein the air supply unit is configured to retrieve a portion of exhaust gas exhausted from the cathodes and admix the portion with the air supplied to the cathode.

4. A fuel cell system comprising a fuel cell having one or more anodes, one or more cathodes and electrolytes respectively put therebetween, comprising:
a fuel supply unit supplying fuel to the anodes;
an air supply unit supplying air to the cathodes;
a heat exchanger having a drain connected to the fuel supply unit; and
an outside air introduction unit introducing outside air and admixing the outside air with the exhaust gas from the cathodes prior to exhaustion of the exhaust gas to an outside.

5. A fuel cell system comprising a fuel cell having one or more anodes, one or more cathodes and electrolytes respectively put therebetween, comprising:
a fuel supply unit supplying fuel to the anodes, the fuel supply unit including a mixing buffer tank;
an air supply unit supplying air to the cathodes; and
an outside air introduction unit introducing an outside air to an exhaust gas from the mixing buffer tank.

6. The fuel cell system of claim 1, wherein the fuel includes one or more liquid organic compounds having water solubility.

7. The fuel cell system of claim 1, wherein the fuel includes one or more liquid organic compounds selected from a group of methanol, dimethyl ether and formic acid

8. The fuel cell system of claim 1, wherein the fuel is methanol.

9. The fuel cell system of claim 1, wherein the fuel supply unit pools concentrated methanol.

10. The fuel cell system of claim 2, wherein the fuel includes one or more liquid organic compounds having water solubility.

11. The fuel cell system of claim 2, wherein the fuel includes one or more liquid organic compounds selected from a group of methanol, dimethyl ether and formic acid

12. The fuel cell system of claim 2, wherein the fuel is methanol.

13. The fuel cell system of claim 2, wherein the fuel supply unit pools concentrated methanol.

14. The fuel cell system of claim 3, wherein the fuel includes one or more liquid organic compounds having water solubility.

15. The fuel cell system of claim 3, wherein the fuel includes one or more liquid organic compounds selected from a group of methanol, dimethyl ether and formic acid

16. The fuel cell system of claim 3, wherein the fuel is methanol.

17. The fuel cell system of claim 3, wherein the fuel supply unit pools concentrated methanol.

18. The fuel cell system of claim 4, wherein the fuel includes one or more liquid organic compounds having water solubility.

19. The fuel cell system of claim 4, wherein the fuel includes one or more liquid organic compounds selected from a group of methanol, dimethyl ether and formic acid

20. The fuel cell system of claim 4, wherein the fuel is methanol.

21. The fuel cell system of claim 4, wherein the fuel supply unit pools concentrated methanol.

22. The fuel cell system of claim 5, wherein the fuel includes one or more liquid organic compounds having water solubility.

23. The fuel cell system of claim 5, wherein the fuel includes one or more liquid organic compounds selected from a group of methanol, dimethyl ether and formic acid

24. The fuel cell system of claim 5, wherein the fuel is methanol.

25. The fuel cell system of claim 5, wherein the fuel supply unit pools concentrated methanol.

26. The fuel cell system of claim 1, wherein the air supply unit is configured to retrieve a portion of exhaust gas exhausted from the cathodes and admix the portion with the air.

27. The fuel cell system of claim 1, further comprising an outside air introduction unit wherein the outside air introduction unit introduces outside air and admix the outside air with the exhaust gas from the cathodes prior to exhaustion of the exhaust gas to an outside.

28. The fuel cell system of claim 1, further comprising a mixing buffer tank and an outside air introduction unit wherein the outside air introduction unit introduces outside air to an exhausted gas from the mixing buffer tank.
